(19) United States
(12) Patent Application Publication
(10) Pub. No.: US 2024/0356425 A1
(43) Pub. Date: Oct. 24, 2024

(54) SYSTEM AND METHOD OF DETERMINING A LOAD VOLTAGE IN A POWER CONVERTER

(71) Applicant: Advanced Energy Industries, Inc., Denver, CO (US)

(72) Inventor: Michael Ostheim-Dzerowycz, Warstein (DE)

(21) Appl. No.: 18/304,510

(22) Filed: Apr. 21, 2023

(51) Int. Cl. H02M 1/00; H02M 7/217

(52) U.S. Cl. CPC H02M 1/0009; H02M 7/217

(57) ABSTRACT

Determining a load voltage across a load includes receiving electrical energy from a voltage source through a voltage input, transferring at least a portion of the received electrical energy to the load through a voltage output via a switching assembly, and determining a voltage of the received electrical energy via a first voltage sensor coupled to the voltage input. Further included is determining a voltage across the switching assembly via a second voltage sensor coupled to the voltage input and to the voltage output and determining the load voltage based on a comparison of the determined voltage of the received electrical energy with the determined voltage across the switching assembly.

### TECHNICAL FIELD

Aspects of the disclosure relate to power controllers and more particularly to current or voltage measurement of different voltage zones in a power controller configured to supply power to a load.

### BACKGROUND

A power controller can be used to supply electrical energy to a load based on a percentage of an input voltage. Input currents and voltages supplied to the power controller by a power source are controllable by the power controller to transmit all of the input power to a load, none of the input power to the load, or a portion of the input power to the load. Applications for such power control include light dimmers, motor speed controllers, resistance heaters, chopper circuits, phase-control circuits, and the like.

### OVERVIEW

In accordance with one aspect, a power controller circuit for controlling energy supplied to a load, the power controller circuit includes a voltage input configured to receive electrical energy from a voltage source, a voltage output configured to transfer at least a portion of the electrical energy to the load, and a switching assembly coupled between the voltage input and the voltage output. The power controller also includes a first voltage sensor coupled with the voltage input and configured to sense a voltage of the received electrical energy, a second voltage sensor coupled across the switching assembly and configured to sense a voltage drop across the switching assembly, and a data processing controller. The data processing controller is configured to control the switching assembly into a conduction mode during a first portion of an energy cycle of the electrical energy to cause the energy to flow through the switching assembly between the voltage source and the load, to determine, via the first voltage sensor, the voltage of the received electrical energy, to determine, via the second voltage sensor, the voltage drop across the switching assembly, and to determine a load voltage across the load via a comparison of the voltage of the received electrical energy and the voltage drop across the switching assembly.

In accordance with another aspect, a method of determining a load voltage across a load includes receiving electrical energy from a voltage source through a voltage input, transferring at least a portion of the received electrical energy to the load through a voltage output via a switching assembly, and determining a voltage of the received electrical energy via a first voltage sensor coupled to the voltage input. The method also includes determining a voltage across the switching assembly via a second voltage sensor coupled to the voltage input and to the voltage output and determining the load voltage based on a comparison of the determined voltage of the received electrical energy with the determined voltage across the switching assembly.

### BRIEF DESCRIPTION OF THE DRAWINGS

The drawings illustrate embodiments presently contemplated for carrying out the invention.

In the drawings:

FIG. 1 is a power controller circuit for controlling input power according to an embodiment.

FIG. 2 illustrates a portion of the power controller circuit 100 of FIG. 1 according to an embodiment.

FIG. 3 illustrates a portion of the power controller circuit 100 of FIG. 1 according to another embodiment.

FIG. 4 illustrates a power controller circuit for controlling input power according to another embodiment.

FIG. 5 illustrates a portion of the power controller circuit 100 of FIG. 4 according to an embodiment.

FIG. 6 illustrates a portion of the power controller circuit 100 of FIG. 4 according to another embodiment.

FIG. 7 illustrates an embodiment of the switch assembly of FIG. 1 according to an embodiment.

FIG. 8 illustrates an embodiment of the switch assembly of FIG. 1 according to another embodiment.

FIG. 9 illustrates an embodiment of the switch assembly of FIG. 8 according to another embodiment.

FIG. 10 illustrates an embodiment of the switch assembly of FIG. 8 according to another embodiment.

### DETAILED DESCRIPTION

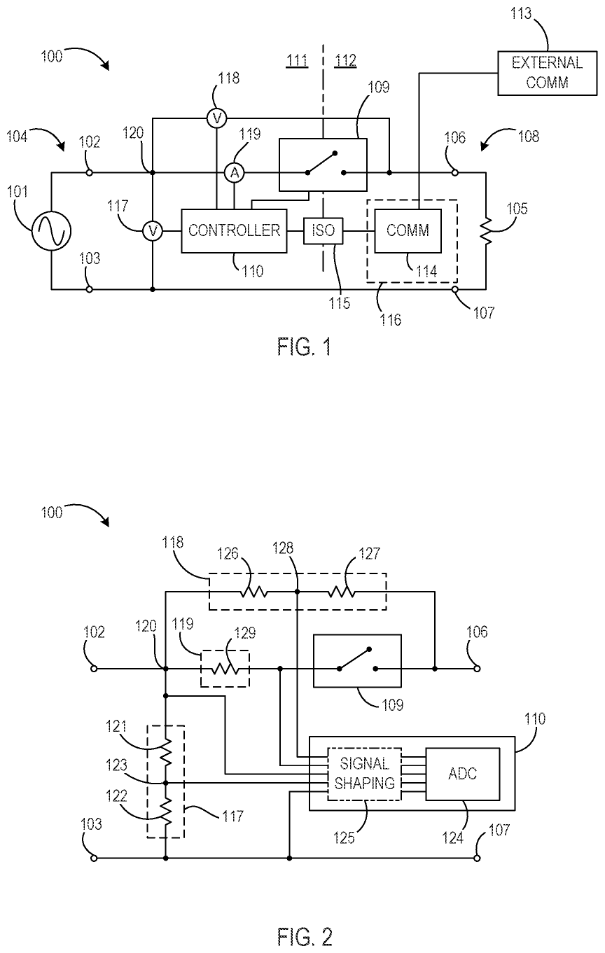

FIG. 1 illustrates a power controller circuit 100 for controlling input power supplied by an input power source 101 through a pair of input terminals 102, 103 of a voltage input 104 to a load 105 coupled to a pair of output terminals 106, 107 of a voltage output 108 according to an embodiment. In an example, the load 105 is a resistance device such as a resistance heater having a heat output determined by a temperature set point. A switch assembly 109 having one or more controllable switches is coupled to a controller 110 for controlling the input power to provide the energy to the heater 105 to produce the desired temperature. The power controller circuit 100 has a first voltage zone (e.g., mains voltage) on an input side 111 and a second voltage zone (e.g., load voltage) on an output side 112. In one example, the second voltage zone is at the same voltage level as the load 105. Due to the on/off control of the switch assembly 109, the voltage separation of the first and second voltage zones is created when the switch assembly 109 is open, and the first voltage zone is higher or lower than the second voltage zone depending on the voltage level of the input power source 101. The first voltage zone is at the same voltage level as the second voltage zone when the switch assembly 109 is closed.

The power controller may benefit from being able to communicate with a communication system 113 external to the power controller circuit 100. The external communication system 113 may be a communication system that communicates via low-power signals. As a result, an internal communication controller 114 may be connected to the controller 110 via an isolation device 115 that separates the voltage levels of the input side 111 from a communication-level voltage domain 116 based on lower power signals than the voltage levels of the input side 111.

Information from the power controller circuit 100 that may be useful or desirable to communicate with the external communication system 113 may include the voltage level of the input power or energy supplied by the input power source 101, the voltage level of the voltage output 108 at the load 105, and the amount of current provided through the switch assembly 109. Other information may also be desirable such as component temperatures, controller statistics, and the like and may also be communicated to the external communication system 113 via the internal communication controller 114 as shared by the controller 110. Further, operations of the controller 110 may rely on measurements of the mains voltage, the load voltage, and the load current.

To measure the mains voltage, the power controller circuit 100 includes a mains voltage sensor 117 coupled across the input terminals 102, 103. To determine the load voltage, a load voltage sensor 118 is coupled across the switch assembly 109. The measured mains voltage minus the voltage across the load voltage sensor 118 yields the load voltage. To measure the load current, a current sensor 119 is coupled between the input terminal 102 and an input to the switch assembly 109. As illustrated in FIG. 1, all three of the sensors (e.g., the mains voltage sensor 117, the load voltage sensor 118, and the current sensor 119) have a connection to a common node 120. Thus, all voltage and current measurements with sensors 117-119 benefit from being based on a single, common reference potential.

FIG. 2 illustrates a portion of the power controller circuit 100 of FIG. 1 according to an embodiment. As shown, the mains voltage sensor 117 may be implemented as a voltage divider via a pair of resistors 121, 122 coupled together at a common node 123. The first resistor 121 of the mains voltage sensor 117 has a terminal coupled with the common node 120, and the second resistor 122 of the mains voltage sensor 117 has a terminal coupled with the input terminal 103. A voltage across the first resistor 121 may be supplied to an analog-to-digital (ADC) 124 of the controller 110 for converting the level of the voltage across the first resistor 121 to a digital value. A signal shaper 125 may alternatively be used to condition the first resistor voltage such as by filtering, amplifying, or the like. Since the voltage measured across the first resistor 121 is proportional to the mains voltage across the mains voltage sensor 117, a constant factor may be applied to the first resistor voltage to determine the mains voltage from the measured value. In one embodiment, the signal shaper 125 may be implemented via a controller. In another embodiment, the signal shaper 125 may be implemented as a passive filter.

To determine the load voltage, the load voltage sensor 118 may be similarly implemented as a voltage divider via a pair of resistors 126, 127 coupled together at a common node 128. The first resistor 126 of the load voltage sensor 118 has a terminal coupled with the common node 120, and the second resistor 127 of the load voltage sensor 118 has a terminal coupled with the output terminal 106. A voltage across the first resistor 126 may be supplied to the ADC 124 for converting the level of the voltage across the first resistor 126 to a digital value. The signal shaper 125 may be used to condition the first resistor voltage. Since the voltage measured across the first resistor 126 is proportional to the voltage across the load voltage sensor 118, a constant factor may be applied to the first resistor voltage to determine the whole voltage across the load voltage sensor 118. The voltage across the load voltage sensor 118, however, does not represent the load voltage. Rather, it represents the difference in voltage between the mains voltage and the load voltage. Accordingly, the controller 110 is configured to subtract the voltage across the load voltage sensor 118 from the determined mains voltage to determine the load voltage.

To determine the load current flowing through the switch assembly 109, the current sensor 119 may be implemented as having a single, sense resistor 129. The resistance of the sense resistor 129 is preferably determined based on a value that minimally impacts current delivery through the switch assembly 109. By measuring a voltage across the sense resistor 129, converting the measured voltage to a digital value via the ADC 124, and dividing the measured voltage by the resistance value of the sense resistor 129, the controller 110 may determine the load current.

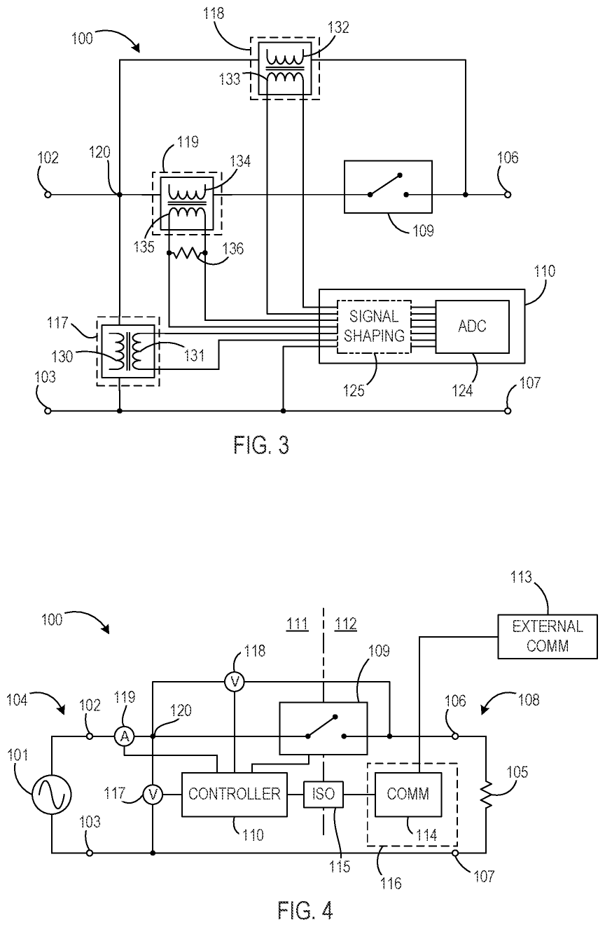

FIG. 3 illustrates a portion of the power controller circuit 100 of FIG. 1 according to another embodiment. As shown, the mains voltage sensor 117 and the load voltage sensor 118 are implemented as voltage measurement transformers. As a voltage spans from the common node 120 to the output terminal 107 through a primary winding 130 of the mains voltage sensor 117 and induce a voltage on a secondary winding 131 of the mains voltage sensor 117, the induced voltage is measured by the controller 110. Similarly, as a voltage spans from the common node 120 to the output terminal 106 through a primary winding 132 of the load voltage sensor 118 and induces a voltage on a secondary winding 133 of the mains voltage sensor 117, the induced voltage is measured by the controller 110.

The current sensor 119 is shown implemented as a current measurement transformer. As a current flows from the common node 120 to switch assembly 109 through a primary winding 134 of the current sensor 119, an induced current flowing through a secondary winding 135 of the mains current sensor 119 induces a voltage across a sense resistor 136 that is measured by the controller 110.

Embodiments of this disclosure contemplate that any of the sensors 117-119 of FIG. 2 may be substituted by any of the sensors 117-119 of FIG. 3. For example, in one example, the voltage divider sensors 117, 118 of FIG. 2 may be combined with a current measurement transformer 119 illustrated in FIG. 3 substituting the single, sense resistor 129 illustrated in FIG. 2. Other combinations are considered within the scope of this disclosure.

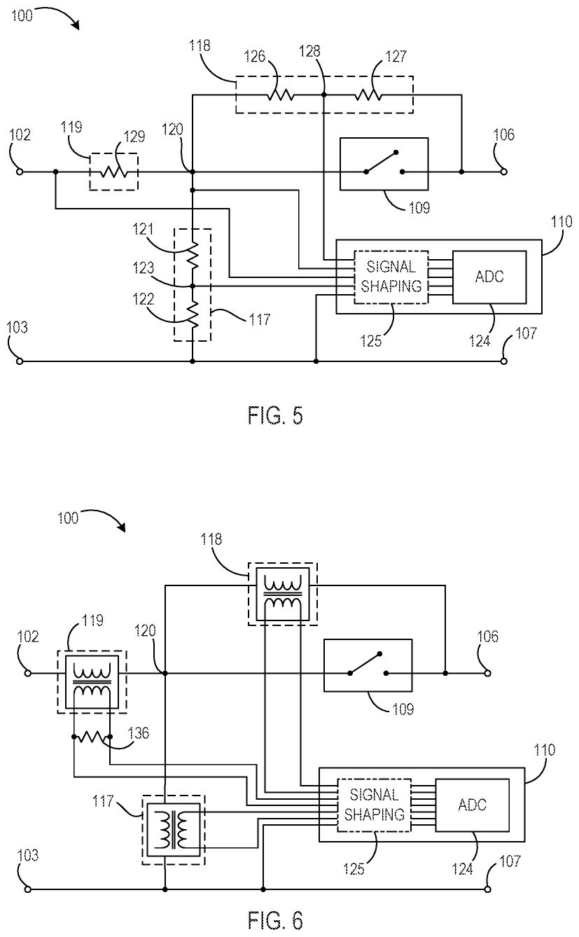

FIG. 4 illustrates the power controller circuit 100 of FIG. 1 according to another embodiment. As shown in FIG. 4, the position of the current sensor 119 is placed between the input terminal 102 and the common node 120. Operation of the rest of the power controller circuit 100 is as described above. FIG. 5 illustrates a portion of the power controller circuit 100 of FIG. 4 according to an embodiment illustrating resistor divider networks for the mains voltage sensor 117 and the load voltage sensor 118 and the single, sense resistor 129 for the current sensor 119 as similarly described with respect to FIG. 2. FIG. 6 illustrates a portion of the power controller circuit 100 of FIG. 4 according to an embodiment illustrating voltage measurement transformers for the mains voltage sensor 117 and the load voltage sensor 118 and the current measurement transformer for the current sensor 119 as similarly described with respect to FIG. 3.

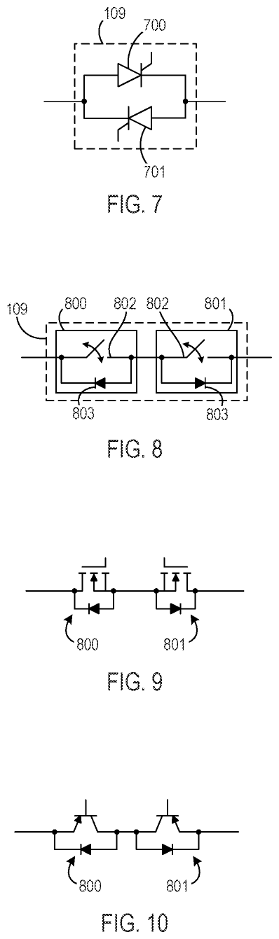

FIG. 7 illustrates an embodiment of the switch assembly 109 of FIG. 1 according to an embodiment. The switch assembly 109 has a pair of thyristors 700, 701 is coupleable to the controller 110 for controlling energy transfer through the switch assembly 109. When turned on in respective AC half cycles, the thyristors 700, 701 begin transferring energy therethrough and turn off in response to a change in the AC half cycle that changes the direction of current flow.

FIG. 8 illustrates an embodiment of the switch assembly 109 of FIG. 1 according to another embodiment. The switch assembly 109 includes multiple controllable switches 800, 801 that are controllable by the controller 110 into a conduction mode and into a non-conduction mode. In the conduction mode, the respective switch 800, 801 is in an on-state capable of transmitting or passing electrical energy therethrough. In the non-conduction mode, the respective switch 800, 801 is in an off-state capable of prohibiting or cutting off the passage of electrical energy therethrough. In an example, each switch 800, 801 includes a controllable switch portion 802 and a diode 803. The diode 803 may be a distinct device or may be formed, for example, by a body diode of a metal oxide-semiconductor field-effect transistor (MOSFET) device.

FIG. 9 illustrates the switches 800, 801 implemented as MOSFETs, while FIG. 10 illustrates the switches 800, 801 implemented as bipolar junction transistors (BJTs). The MOSFETs may be silicon MOSFETs, silicon carbide MOSFETs, and the like. Other types of switches and topologies of switching elements single or plural capable of being controlled into both the conduction and non-conduction states are also contemplated herein.

By arranging the mains voltage sensor and load voltage sensor as described herein, all measurements are accomplished with a single common reference potential. That is, the mains voltage and the load voltage are based on the same voltage potential. The load voltage is measured indirectly by measuring the voltage drop over switch. Furthermore, the load voltage can be measured with voltage dividers to avoid additional disturbance variables.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the invention is not to be seen as limited by the foregoing description but is only limited by the scope of the appended claims.

1. A power controller circuit for controlling energy supplied to a load, the power controller circuit comprising:
a voltage input configured to receive electrical energy from a voltage source;
a voltage output configured to transfer at least a portion of the electrical energy to the load;
a switching assembly coupled between the voltage input and the voltage output;
a first voltage sensor coupled with the voltage input and configured to sense a voltage of the received electrical energy;
a second voltage sensor coupled across the switching assembly and configured to sense a voltage drop across the switching assembly; and
a data processing controller configured to:
control the switching assembly into a conduction mode during a first portion of an energy cycle of the electrical energy to cause the energy to flow through the switching assembly between the voltage source and the load;
determine, via the first voltage sensor, the voltage of the received electrical energy;
determine, via the second voltage sensor, the voltage drop across the switching assembly; and
determine a load voltage across the load via a comparison of the voltage of the received electrical energy and the voltage drop across the switching assembly.

2. The power controller circuit of claim 1, wherein the data processing controller is configured to determine the voltage drop across the switching assembly and the voltage of the received electrical energy based on a common voltage potential.

3. The power controller circuit of claim 2, wherein the data processing controller is configured to determine the load voltage by subtracting the voltage drop across the switching assembly from the voltage of the received electrical energy.

4. The power controller circuit of claim 2, wherein the common voltage potential is a voltage potential of the voltage input.

5. The power controller circuit of claim 4, wherein a voltage potential of the voltage output is different from the voltage potential of the voltage input.

6. The power controller circuit of claim 2, wherein the second voltage sensor comprises a first resistor serially coupled with a second resistor via a common second voltage sensor node;
wherein the voltage input comprises a first input terminal coupled with the first voltage sensor and the second voltage sensor via a common input node;
wherein the first resistor is coupled between the common input node and the common second voltage sensor node; and
wherein the second resistor is coupled between the common second voltage sensor node and the voltage output.

7. The power controller circuit of claim 6, wherein the first voltage sensor comprises a third resistor serially coupled with a fourth resistor via a common first voltage sensor node;
wherein the voltage input further comprises a second input terminal coupled with the fourth resistor; and
wherein the third resistor is coupled between the common input node and the common first voltage sensor node.

8. The power controller circuit of claim 7, wherein the data processing controller comprises an analog-to-digital converter coupled with the common input node, the common first voltage sensor node, the common second voltage sensor node, and the second input terminal;
wherein the analog-to-digital converter is configured to convert a first analog voltage at the common first voltage sensor node to a first digital voltage; and
wherein the analog-to-digital converter is configured to convert a second analog voltage at the common second voltage sensor node to a second digital voltage.

9. The power controller circuit of claim 8, wherein the data processing controller comprises a signal shaper controller configured to modify the first analog voltage prior to the digital conversion by the analog-to-digital converter.

10. The power controller circuit of claim 8 further comprising a data communication controller in communication with the analog-to-digital converter via an isolation device;
wherein the data communication controller is configured to communicate the first and second digital voltages to a communication system external to the power controller circuit.

11. The power controller circuit of claim 8 further comprising a current sensor coupled between the voltage input and the switching assembly and configured to sense a current flowing through the switching assembly.

12. The power controller circuit of claim 11, wherein the current sensor comprises a sense resistor; and
wherein the analog-to-digital converter is further configured to:
convert a sense voltage across the resistor to a third digital voltage; and
determine a current passing through the sense resistor based on the third digital voltage and a resistance of the sense resistor.

13. The power controller circuit of claim 1, wherein the switching assembly is bi-directional.

14. A method of determining a load voltage across a load comprising:
receiving electrical energy from a voltage source through a voltage input;
transferring at least a portion of the received electrical energy to the load through a voltage output via a switching assembly;
determining a voltage of the received electrical energy via a first voltage sensor coupled to the voltage input;
determining a voltage across the switching assembly via a second voltage sensor coupled to the voltage input and to the voltage output; and
determining the load voltage based on a comparison of the determined voltage of the received electrical energy with the determined voltage across the switching assembly.

15. The method of claim 14, wherein the first voltage sensor and the second voltage sensor share a common node.

16. The method of claim 15, further comprising determining a current flowing through the switching assembly via:
measuring a voltage across a sense resistor; and
determining the current flowing through the switching assembly based on the measured voltage and a resistance of the sense resistor;
wherein the sense resistor is coupled with the common node.

17. The method of claim 14, wherein determining the load voltage comprises subtracting the determined voltage across the switching assembly from the determined voltage of the received electrical energy.

18. The method of claim 14, wherein each of the first and second voltage sensors comprises a resistor divider comprising a first resistor serially coupled with a second resistor via a common node.

19. The method of claim 18, wherein determining the voltage of the received electrical energy via the first voltage sensor comprises measuring a voltage across the first resistor;
wherein the first resistor is coupled with a first terminal of the voltage input; and
wherein the second resistor is coupled with a second terminal of the voltage input.

20. The method of claim 18 wherein determining the voltage across the switching assembly via the second voltage sensor comprises measuring a voltage across the first resistor;
wherein the first resistor is coupled with a first terminal of the voltage input; and
wherein the second resistor is coupled with a first terminal of the voltage output.
